(19) United States
(12) Patent Application Publication
(10) Pub. No.: US 2016/0269513 A1
(43) Pub. Date: Sep. 15, 2016

(54) SHELL COMPONENT FOR ELECTRONIC DEVICE, ELECTRONIC DEVICE AND METHOD FOR MANUFACTURING SHELL COMPONENT

(71) Applicants: Huawei Technologies Co., Ltd., Shenzhen (CN); Nippon Steel & Sumikin Materials Co., Ltd., Tokyo (JP)

(72) Inventors: Ueno HIROKI, Tokyo (JP); Onda YUICHI, Tokyo (JP); Shinkichi MURAKAMI, Tokyo (JP)

(21) Appl. No.: 15/078,777

(22) Filed: Mar. 23, 2016

Related U.S. Application Data
(63) Continuation of application No. PCT/CN2013/084108, filed on Sep. 24, 2013.

(51) Int. Cl. H04M 1/02; D03D 1/00; H04B 1/3827

(52) U.S. Cl. CPC H04M 1/0249; H04B 1/3833; D03D 1/0088

(57) ABSTRACT

The present disclosure provides a shell component for an electronic device, an electronic device and a method for manufacturing the shell component. The shell component includes a first portion made of non-conductive fibers, wherein the first portion is positioned near to a location of an antenna of the electronic device when assembled; and a second portion made of fibers which are at least partially different from the non-conductive fibers of the first portion. When the shell component provided by embodiments of the present disclosure is assembled to an electronic device, the first portion does not block the radio frequency signals because it is made of non-conductive material woven of non-conductive fibers, thereby preventing radio frequency performance being affected.

### CROSS-REFERENCE TO RELATED APPLICATIONS

This application is a continuation of International Patent Application No. PCT/CN2013/084108, filed on Sep. 24, 2013, which is hereby incorporated by reference in its entirety.

### TECHNICAL FIELD

The present disclosure relates to the field of communications technologies, and in particular, to a shell component for an electronic device, an electronic device with the shell component and a method for manufacturing the shell component.

### BACKGROUND

With the development of communications technologies, electronic devices, such as mobile phone, mobile router, tablet PC, laptop PC or gaming device etc. are required to be lighter and thinner, so light, thin as well as strong material is needed to form the shell of electronic device.

Carbon fiber woven material is an ideal material to reduce weight and thickness of the shell of an electronic device due to its light weight and high strength.

However, since carbon fibers are electrically conductive, shells formed by carbon fiber material block radio frequency signals which can hardly pass through the shells, thereby seriously affecting the radio frequency performance of the electronic device.

### SUMMARY

Embodiments of the present disclosure provide an shell component for an electronic device, an electronic device with the shell component and a method for manufacturing the shell component to solve the problem that shells formed by carbon fiber material block radio frequency signals.

An aspect of the present disclosure provides a shell component for an electronic device, where the shell component includes:

a first portion made of non-conductive fibers, wherein the first portion is positioned near to a location of an antenna of the electronic device when assembled;

a second portion made of fibers which are at least partially different from the non-conductive fibers of the first portion.

Another aspect of the present disclosure provides an electronic device comprising a memory, a processor coupled to the memory, an antenna coupled to the processor and the above shell component for an electronic device.

Another aspect of the present disclosure provides a method for manufacturing a shell component for an electronic device, comprising:

producing a mixed woven sheet woven of non-conductive fibers and conductive fibers, wherein the mixed woven sheet includes a non-conductive area merely woven of non-conductive fibers;

forming the mixed woven sheet to a shape of a shell component for an electronic device, wherein the shell component comprise a first portion and a second portion, the first portion is formed by the non-conductive area and positioned near to a location of an antenna of the electronic device when assembled to the electronic device, and fibers of the second portion are at least partially different from non-conductive fibers of the first portion.

When the shell component provided by embodiments of the present disclosure is assembled to an electronic device, the first portion does not block the radio frequency signals because it is made of non-conductive material woven of non-conductive fibers, thereby preventing radio frequency performance being affected.

### BRIEF DESCRIPTION OF DRAWINGS

FIG. 1 is a schematic view of an electronic device including a shell component according to an embodiment of the present disclosure;

FIG. 2 is a schematic view of the shell component of the electronic device shown in FIG. 1;

FIG. 3 is a schematic view of a shell component according to another embodiment of the present disclosure;

FIG. 4 is a schematic view of a shell component according to another embodiment of the present disclosure;

FIG. 5A is a schematic view of a shell component according to another embodiment of the present disclosure;

FIG. 5B is a schematic sectional view of the shell component taken along section line A-A of FIG. 5A;

FIG. 6 is a schematic sectional view of a shell component according to another embodiment of the present disclosure;

FIG. 7 is a schematic view of a shell component according to another embodiment of the present disclosure;

FIG. 8 is a schematic view of a shell component according to another embodiment of the present disclosure;

FIG. 9 is a flowchart of the method for manufacturing a shell component according to another embodiment of the present disclosure;

FIG. 10A is a schematic view of a shell component according to another embodiment of the present disclosure.

FIG. 10B is an enlarged view of the circular section of FIG. 10A.

### DESCRIPTION OF EMBODIMENTS

The technical solution of the present disclosure is hereinafter described in detail with reference to the accompanying drawings. It is evident that the embodiments are only some exemplary embodiments of the present disclosure, and the present disclosure is not limited to such embodiments. Other embodiments that those skilled in the art obtain based on embodiments of the present disclosure also all within the protection scope of the present disclosure.

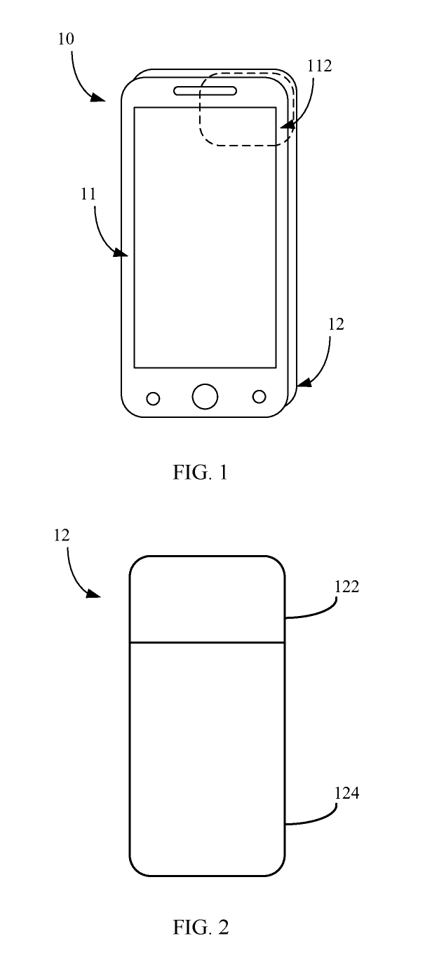

With reference to FIG. 1 and FIG. 2, in an embodiment, an electronic device 10 such as a mobile phone has a front side 11 where a display screen is located and a shell component 12 which is provided on the back side opposite to the front side 11. The shell component 12 can be formed as a part of the electronic device 10 fixedly, removably, or slidably, or can be made as an independent shell that can be attached to and detached from an independent electronic device 10 as desired.

The electronic device 10 may include a memory (not shown) for storing instructions and data; a processor (not shown), coupled to the memory, configured to execute the instructions and process the data; and an antenna 112 coupled to the processor for transmitting and receiving radio frequency signals. The processor, the memory and the antenna 112 are located inside the electronic device 10. In FIG. 1 the antenna 112 is schematically marked with dashed line. The shell component 12 has a non-conductive portion 122 and a conductive portion 124, where the non-conductive portion 122 is made of non-conductive material such as woven non-conductive fibers, while the conductive portion 124 is made of conductive material such as woven conductive fibers, or made from the combination of woven conductive fibers and non-conductive fibers.

The portion 122 is positioned near to the location of the antenna 112 so that the radio frequency signals emitted by the antenna can pass through the portion 122 without being blocked. It means that, when the shell component 12 is assembled to the electronic device 10, the portion 122 covers the area where the antenna 112 is located. Since the portion 122 is made of non-conductive material, radio frequency signals can pass through the portion 122 of the shell component 12 and thereby the antenna 112 can transmit and receive radio frequency signals to communicate with a network or other equipment. The portion 124 can be made from conductive fibers such as carbon fiber, metal fiber, or the mixture thereof. The non-conductive fibers may be glass fibers or nylon fibers as well as other type of non-conductive fibers.

Although the electronic device in this specific embodiment is a mobile phone, it should be understood that the electronic device in other embodiments can be a mobile router, a tablet PC, a laptop PC or a gaming device etc.

The shell component 12 includes a non-conductive portion 122 and a conductive portion 124, so that radio frequency signals can pass through the non-conductive portion 122 of the shell component 12, while the material of the conductive portion 124 can be selected to provide light weight, thin thickness, high strength, elegant appearance, and good touch feeling properties. Therefore, besides having light weight, thin thickness, high strength, elegant appearance and good touch feeling properties, the shell component 12 also allows radio frequency signals to pass through via the non-conductive portion 122.

The pattern and arrangement of the non-conductive portion 122 can be determined according to the number of antennas as well as the location of antennas, so that all antennas are covered by a near non-conductive portion 122. The non-conductive portion 122 can be a single continuous portion or several separated portions. The shell component 12 may cover substantially the entire back side but with through a hole exposing, for example, a camera lens or other part of the electronic device 10 as desired. The shell component 12 may also partially or substantially entirely cover sidewalls of the electronic device 10, which extend between the front side and the back side. In the embodiment shown in FIG. 2, the shell component 12 has one non-conductive portion 122 and one conductive portion 124 smoothly connected to the non-conductive portion 122 along a substantially straight line.

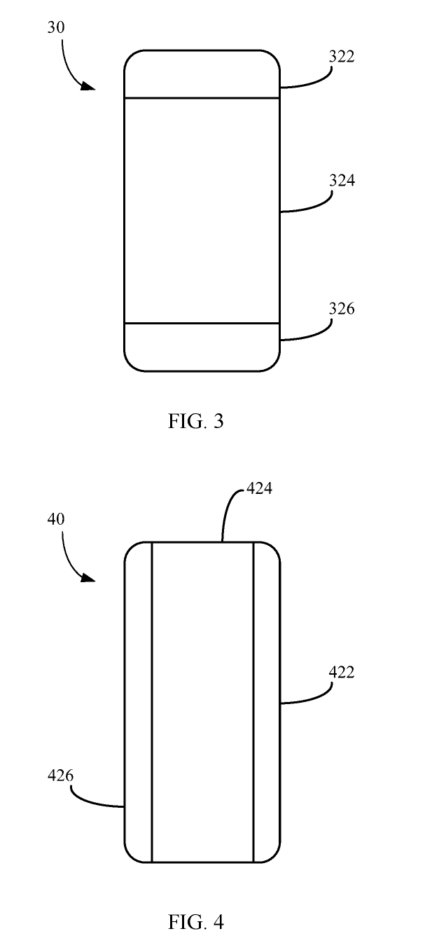

FIG. 3 shows another embodiment of the shell component. The shell component 30 is a back cover of a mobile phone. The mobile phone has WiFi (wireless fidelity) function, GPS (global positioning system) function and Bluetooth function and accordingly it may have four antennas, specifically a WiFi antenna, a GPS antenna, a Bluetooth antenna as well as a cellular antenna. The antennas are located in the top part and the bottom part of the mobile phone, respectively, so the top portion 322 and the bottom portion 326 of the shell component 30 are made of non-conductive woven material to allow radio frequency signals to pass through. Antennas can transmit and receive radio frequency signals through the top portion 322 and the bottom portion 326. The middle portion 324 can be made of conductive woven material, non-conductive woven material or the combination of the two.

In another embodiment, the antennas are arranged at the left side part and right side part of the electronic device. Therefore, as shown in FIG. 4, the left portion 426 and the right portion 422 of the shell component 40 are made of non-conductive woven material and the middle portion 424 can be made of conductive woven material, non-conductive woven material or the combination of the two.

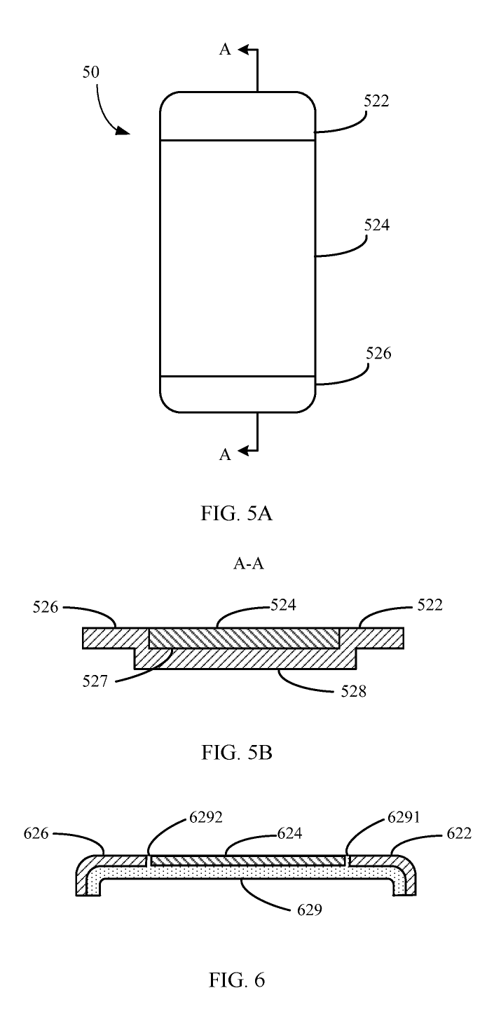

FIG. 5A and FIG. 5B show another embodiment of the shell component according to the present disclosure. FIG. 5B is a schematic sectional view of the shell component 50 taken along section line A-A of FIG. 5A. The shell component 50 includes two separated portion, a non-conductive portion 528 and a conductive portion 524. The non-conductive portion 528 includes two step parts 522, 526 at two ends and a recess 527 in the middle to accommodate the conductive portion 524. The thickness of the second portion 524 equals to the depth of the recess 527. Accordingly, the surface of the shell component 50 is divided into three area, i.e. the top area which is the surface of the step part 522, the middle area which is the surface of the portion 524 and the bottom area which the surface of the step part 526. The portion 528 is made of woven non-conductive fibers, while the portion 524 is made of woven conductive fibers or made of the combination of woven conductive fibers and non-conductive fibers. The portion 524 can be adhered to the portion 528, or assembled with the portion 528 by other existing method, such as sheet forming. Since the portion 528 is made of non-conductive material, it does not block radio frequency signals from passing through.

FIG. 6 shows a schematic sectional view of another embodiment of the shell component according to the present disclosure. In this embodiment, the shell component has two round transition ends and includes two non-conductive portions 622 and 626, one conductive portion 624 and one base 629. The two non-conductive portions 622 and 626, the conductive portion 624 are fixedly attached to the base 629. The non-conductive portions 622, 626 are positioned near to the location of the antennas of the electronic device. The base 629 forms the inner layer of the shell component, while the non-conductive portions 622 and 626 and the conductive portion 624 constitute the outer layer of the shell component. The non-conductive portions 622 and 626 are made of non-conductive woven material, such as glass fiber woven material or nylon fiber woven material. The conductive portion 624 is made of conductive woven material, such as carbon fiber woven material or metal fiber woven material. The base 629 is made of non-conductive material, such as engineering plastics. The shell component shown in FIG. 6 can be manufactured by insert molding. Specifically, the non-conductive portions 622, 626 and the conductive portion 624 are formed firstly; then the non-conductive portions 622, 626 and the conductive portion 624 are set into an injection tooling; after that, the shell component is formed through insert molding by use of the infection tooling. During insert molding, the injected material enters into the small gap between the non-conductive portions 622 and the conductive portion 624, and the small gap between the non-conductive portions 626 and the conductive portion 624, to form two protruding parts 6291 and 6292. In other words, the conductive portion 624 is accommodated in a recess between the two protruding parts 6291 and 6292 of the base 629. Since the portions 622, 626 and the base are made of non-conductive material, the shell component does not prevent radio frequency signals from passing through.

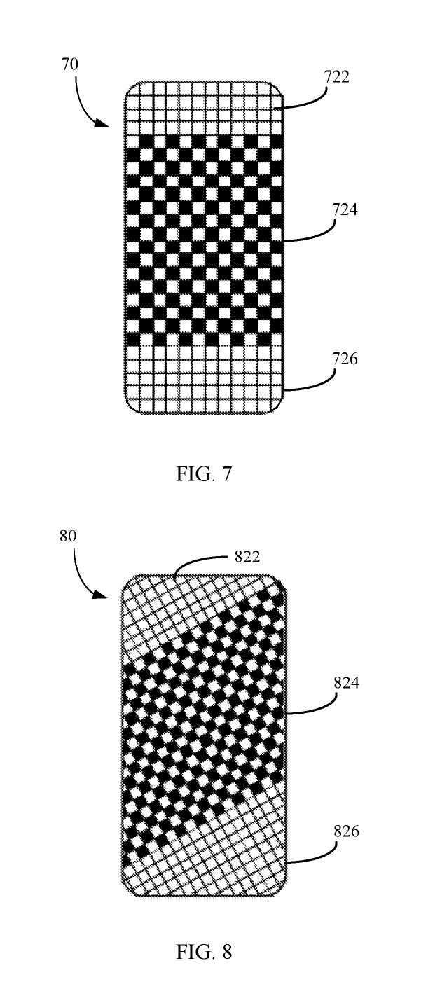

FIG. 7 shows a schematic view of another embodiment of the shell component according to the present disclosure. The shell component 70 is formed by multiple fibers interwoven longitudinally and transversely, generating a texture of regularly arranged squares with the patterns in the non-conductive portion and the conductive portion are aligned with each other, which give an elegant appearance and good touch feeling.

In an embodiment, the shell component 70 can be made by non-conductive fibers extending longitudinally along the entire length from the top to the bottom of the shell component 70 across the entire width of the shell component 70, non-conductive fibers extending transversely along the entire width in the top portion 722 and the bottom portion 726 of the shell component 70, and conductive fibers extending transversely along the entire width in the middle portion 724 of the shell component 70, so that the top portion 722 and the bottom portion 726 of the shell component 70 are non-conductive and the connection between the middle portion 724 and the top portion 722 and the connection between the middle portion 724 and the bottom portion 726 are smooth.

The portions 722 and 726 are positioned near to the location of the antennas of the electronic device when the shell component 70 is assembled to the electronic device. Since the portions 722, 726 are made of non-conductive material, the shell component 70 does not prevent radio frequency signals from passing through.

In the middle portion 724 of the shell component 70, which appears a texture of multiple alternatively arranged squares, the fibers extending transversely are conductive fibers, so the middle portion 724 of the shell component 70 are woven of non-conductive fibers and conductive fibers. In another embodiment, the fibers extending transversely in the middle portion 724 of the shell component 70 may include conductive fibers and non-conductive fibers.

In this embodiment, the non-conductive portions 722, 726 and the conductive portion 724 are woven to be integrated as a whole, so these portions need not to be further adhered or otherwise connected together. Compared with the shell component formed by separated portions, the shell component of this embodiment is much stronger.

Moreover, as the non-conductive portions 722, 726 and the conductive portion 724 are woven to be integrated as a whole, the shell component shows a good pattern alignment so as to provide a good visual effect for users; while, for the shell component formed by separated portions, it is difficult to align the patterns of the separated portions well.

In this embodiment, the fibers appear to be woven along longitude and transverse direction and the shell component 70 appears a texture of multiple regularly arranged squares. In other embodiment, the fibers can also appear to be woven along other directions and appears other pattern of texture, for example, as shown in FIG. 8, the fibers incline at a certain angle.

As shown in FIG. 8, the shell component 80 includes a top portion 822, a middle portion 824 and a bottom portion 826. The top portion 822 and the bottom portion 826 are in a triangle-like shape, while the middle portion 824 is in a parallelogram-like shape. The shell component 80 is woven of first non-conductive fibers, second fibers and third non-conductive fibers. The third non-conductive fibers extend across the entire shell component 80 along a first direction which forms an acute angle, for example 30°, with the longitudinal direction of the shell component 80. The top portion 822 and the bottom portion 826 include the first non-conductive fibers interwoven with the third non-conductive fibers, and the middle portion 824 includes the second fibers interwoven with the third non-conductive fibers. The first non-conductive fibers and the second fibers can be interwoven with the third non-conductive fibers vertically or in an angle other than right angle. The second fibers can be conductive fibers or include both conductive fibers and non-conductive fibers. The first non-conductive fibers and the third non-conductive fibers can include same non-conductive fibers, for example, the first non-conductive fibers and the third non-conductive are both glass fibers, or include different fibers, for example, the first non-conductive fibers include glass fibers while the third non-conductive fibers include nylon fibers. Therefore, the top portion 822 and the bottom portion 826 of the shell component 80 are non-conductive, the connection between the middle portion 824 and the top portion 822 and the connection between the middle portion 824 and the bottom portion 826 are smooth, and the shell component 80 shows a good pattern alignment.

The manners of arrangements and connections of non-conductive fibers and conductive fibers described in the embodiments shown in FIGS. 7 and 8 can also apply to other embodiments. For example, in the shell component shown in FIG. 4, non-conductive fibers can extend transversely through the entire width across the shell component, while conductive fibers extend longitudinally through the entire length in the middle portion of the shell component and non-conductive fibers can be used to extend longitudinally through the entire length in the left and right portions of the shell component.

The fibers constituting the shell component may have a same diameter, or have at least two different diameters to show a desired texture or pattern.

The thickness of the shell component is in a range of 0.2 mm to 0.5 mm, preferably 0.2 mm to 0.4 mm, which is much less than that of a normal shell.

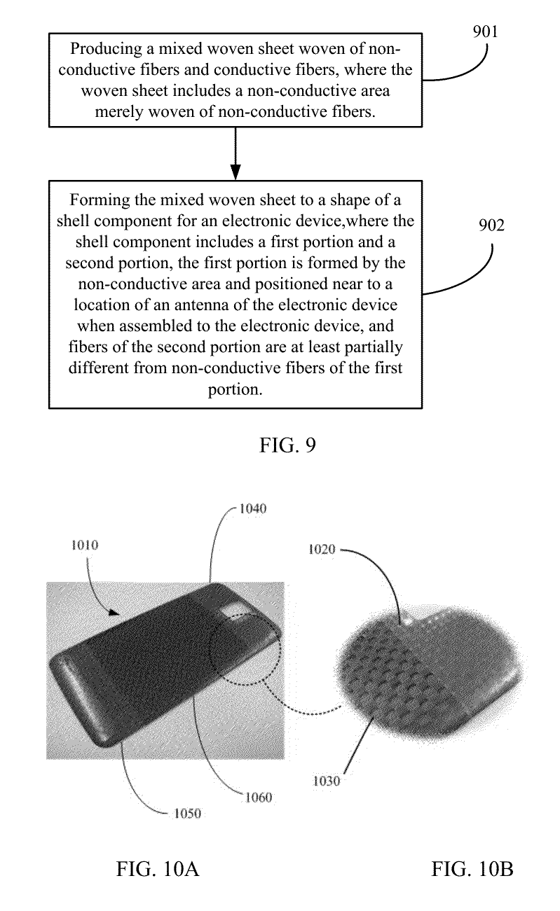

With reference to FIG. 9, a method for manufacturing the shell component according to an embodiment of the present disclosure can include:

Step 901, Producing a mixed woven sheet woven of non-conductive fibers and conductive fibers, where the woven sheet includes a non-conductive area merely woven of non-conductive fibers;

Step 902, Forming the mixed woven sheet to a shape of a shell component for an electronic device, where the shell component includes a first portion and a second portion, the first portion is formed by the non-conductive area and positioned near to a location of an antenna of the electronic device when assembled to the electronic device, and fibers of the second portion are at least partially different from non-conductive fibers of the first portion.

The conductive fibers include carbon fiber, metal fiber, or the mixture thereof. The non-conductive fibers may be glass fibers or nylon fibers as well as other type of non-conductive fibers.

The sheet can be woven to appear various patterns, as long as it includes one or more non-conductive areas for covering the antenna area of the electronic device so as to allow radio frequency signals to pass through.

When forming the shell component, at least part of the non-conductive area (areas) should be positioned near to the location of the antenna (antennas) to form the first portion covering the antenna area. The shell component may appear to be woven longitudinally and transversely, for example, as shown in FIG. 7, or appear to be woven along other directions, for example, as shown in FIG. 8.

The fibers constituting the shell component may have a same diameter, or have at least two different diameters to show a desired texture or pattern.

The thickness of the shell component is in a range of 0.2 mm to 0.5 mm, preferably 0.2 mm to 0.4 mm, which is much less than that of a normal shell.

FIGS. 10A and 10B show another embodiment of the shell component according to the present disclosure. FIG. 10B is an enlarged view of the circular section of FIG. 10A. The shell component 1010 is a prototype of a back cover of an electronic device. The shell component 1010 is formed by mixed woven sheet. The two end portions 1040 and 1050 of the shell component 1010, which are positioned near to the location of antennas of an electronic device, are made of non-conductive fibers 1020, such as glass fiber, nylon fiber and so on; while the middle portion 1060 of the shell component 1010 are woven of non-conductive fibers 1020 and conductive fibers 1030 such as carbon fiber, metal fiber and so on. When the shell component 1010 is assembled to the electronic device, it will not prevent radio frequency signals from passing through since the two end portions 1040 and 1050 are made of non-conductive fibers 1020. The connection between the middle portion 1060 and the top portion 1040 and the connection between the middle portion 1060 and the bottom portion 1050 are smooth, and the shell component 1010 shows a good pattern alignment.

The foregoing descriptions are merely exemplary embodiments of the present disclosure, but not intended to limit the protection scope of the present disclosure. Any variation or replacement made by persons skilled in the art without departing from the spirit and principle of the present disclosure should fall within the protection scope of the present disclosure. Therefore, the protection scope of the present disclosure is subject to the protection scope of the claims.

What is claimed is:

1. A shell component for an electronic device, comprising:
a first portion made of non-conductive fibers, wherein the first portion is positioned adjacent to a location of an antenna of the electronic device when assembled;
a second portion made of fibers which are at least partially different from the non-conductive fibers of the first portion.

2. The shell component according to claim 1, wherein the first portion has a recess to accommodate the second portion and a thickness of the second portion equals to a depth of the recess.

3. The shell component according to claim 1, further comprising a non-conductive base, wherein the first portion and the second portion are fixedly attached to the non-conductive base, the non-conductive base constitutes an inner layer of the shell component, and the first portion and the second portion constitute an outer layer of the shell component.

4. The shell component according to claim 1, wherein,
the first portion comprises first non-conductive fibers extending transversely along an entire width of the shell component;
the second portion comprises second fibers extending transversely along the entire width of the shell component; and
the first non-conductive fibers and the second fibers are interwoven with third non-conductive fibers extending longitudinally along an entire length of the shell component across the entire width of the shell component.

5. The shell component according to claim 1, wherein,
the first portion comprises first non-conductive fibers extending longitudinally along an entire length of the shell component;
the second portion comprises second fibers extending longitudinally along the entire length of the shell component; and
the second non-conductive fibers and the third fibers are interwoven with third non-conductive fibers extending transversely along an entire width of the shell component across the entire length of the shell component.

6. The shell component according to claim 1, wherein,
the first portion comprises first non-conductive fibers;
the second portion comprises second fibers extending parallel to the first non-conductive fibers; and
the first non-conductive fibers and the second fibers are interwoven with third non-conductive fibers extending along a direction at an acute angle to a longitudinal direction of the shell component.

7. The shell component according to claim 4, wherein the second fibers comprise conductive fibers and non-conductive fibers.

8. The shell component according to claim 5, wherein the second fibers comprise conductive fibers and non-conductive fibers.

9. The shell component according to claim 6, wherein the second fibers comprise conductive fibers and non-conductive fibers.

10. The shell component according to claim 4, wherein the second fibers comprise conductive fibers.

11. The shell component according to claim 5, wherein the second fibers comprise conductive fibers.

12. The shell component according to claim 6, wherein the second fibers comprise conductive fibers.

13. The shell component according to claim 4, wherein the first non-conductive fibers, the second fibers and the third non-conductive fibers have at least two different diameters.

14. The shell component according to claim 5, wherein the first non-conductive fibers, the second fibers and the third non-conductive fibers have at least two different diameters.

15. The shell component according to claim 6, wherein the first non-conductive fibers, the second fibers and the third non-conductive fibers have at least two different diameters.

16. An electronic device, comprising a memory, a processor coupled to the memory, an antenna coupled to the processor, and a shell component for the electronic device;
the shell component comprises:
a first portion made of non-conductive fibers, wherein the first portion is positioned adjacent to a location of an antenna of the electronic device when assembled;
a second portion made of fibers which are at least partially different from the non-conductive fibers of the first portion.

17. The electronic device according to claim 16, wherein the first portion has a recess to accommodate the second portion, and a thickness of the second portion equals to a depth of the recess.

18. The electronic device according to claim 16, wherein the shell component further comprises a non-conductive base, wherein the first portion and the second portion are fixedly attached to the non-conductive base, the non-conductive base constitutes an inner layer of the shell component, and the first portion and the second portion constitute an outer layer of the shell component.

19. The electronic device according to claim 16, wherein,
the first portion comprises first non-conductive fibers extending transversely along an entire width of the shell component;
the second portion comprises second fibers extending transversely along the entire width of the shell component; and
the first non-conductive fibers and the second fibers are interwoven with third non-conductive fibers extending longitudinally along an entire length of the shell component across the entire width of the shell component.

20. The electronic device according to claim 16, wherein,
the first portion comprises first non-conductive fibers extending longitudinally along an entire length of the shell component;
the second portion comprises second fibers extending longitudinally along the entire length of the shell component; and
the second non-conductive fibers and the third fibers are interwoven with third non-conductive fibers extending transversely along an entire width of the shell component across the entire length of the shell component.

21. The electronic device according to claim 16, wherein,
the first portion comprises first non-conductive fibers;
the second portion comprises second fibers extending parallel to the first non-conductive fibers; and
the first non-conductive fibers and the second fibers are interwoven with third non-conductive fibers extending along a direction at an acute angle to a longitudinal direction of the shell component.

22. A method for manufacturing a shell component for an electronic device, the method comprising:
producing a mixed woven sheet woven of non-conductive fibers and conductive fibers, wherein the mixed woven sheet includes a non-conductive area which is only woven of non-conductive fibers;
forming the mixed woven sheet to a shape of a shell component for an electronic device, wherein the shell component comprises a first portion and a second portion, the first portion is formed by the non-conductive area and positioned adjacent to a location of an antenna of the electronic device when assembled to the electronic device, and fibers of the second portion are at least partially different from non-conductive fibers of the first portion.

23. The method according to claim 22, wherein,
the first portion comprises first non-conductive fibers extending transversely along an entire width of the shell component;
the second portion comprises second fibers extending transversely along the entire width of the shell component; and
the first non-conductive fibers and the second fibers are interwoven with third non-conductive fibers extending longitudinally along an entire length of the shell component across the entire width of the shell component.

24. The method according to claim 22, wherein,
the first portion comprises first non-conductive fibers extending longitudinally along an entire length of the shell component;
the second portion comprises second fibers extending longitudinally along the entire length of the shell component; and
the second non-conductive fibers and the third fibers are interwoven with third non-conductive fibers extending transversely along an entire width of the shell component across the entire length of the shell component.

25. The method according to claim 22, wherein,
the first portion comprises first non-conductive fibers;
the second portion comprises second fibers extending parallel to the first non-conductive fibers; and
the first non-conductive fibers and the second fibers are interwoven with third non-conductive fibers extending along a direction at an acute angle to a longitudinal direction of the shell component.
